(19) United States
(12) Patent Application Publication
(10) Pub. No.: US 2005/0125789 A1
(43) Pub. Date: Jun. 9, 2005

(54) Executing processes in a multiprocessing environment

(75) Inventors: Hendrik Dijkstra, Hilversum (NL); Antonie Dijkhof, Hilversum (NL); Simon Tony Dekker, Hilversum (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V. Groenewoudseweg 1, BA Eindhoven (NL)

(21) Appl. No.: 10/502,144

(22) PCT Filed: Dec. 19, 2002
(86) PCT No.: PCT/IB02/05632

(30) Foreign Application Priority Data
Jan. 24, 2002 (EP) 02075299.4

(51) Int. Cl. G06F 9/46

(52) U.S. Cl. 718/100

(57) ABSTRACT

This invention relates to a method and a system for executing processes with different priorities in a multiprocessing environment comprising execution of a low priority process and a high priority process where the high priority process and the low priority process (T1) share a given resource, the method comprising the step of: raising the effective priority of the low priority process when the low priority process is going to use the shared resource, where the effective priority is raised to above other processes in the multiprocessing environment. This allows for as short delay, by other processes, of the high priority process as possible.

The invention relates to a method, and a corresponding system, of executing processes with different priorities in an operating system run by a computing device. More particularly, the invention relates to a method, and a corresponding system, of executing processes with different priorities using a shared resource in an operating system providing a multiprocessor or multiprocessing environment.

Software of hard or critical real-time systems typically comprises a high priority thread, process, task, job, etc. (these terms are used interchangeably throughout the text) responsible for performing time-critical actions or processing. Usually, such systems also comprise a thread of lower or low priority responsible for performing background actions or processing.

The processing of the low priority thread may be pre-empted by the high priority thread and by other thread(s) (called intermediate priority thread(s) in the following) whose priority lies between that of the high priority thread and the low priority thread.

A thread, task, process or job is a part of a program that can execute independently of other parts. Operating systems that support multithreading enable programmers to design programs whose threaded parts can execute concurrently.

Threads with different or same priority may communicate through or use a shared resource like a memory or file, part of a memory or file, etc. Access to a shared resource is typically protected or handled by a program object that ensures that only one thread is allowed to access the given resource, e.g. so that one thread does not try to read from a memory before (or while) another thread has finished writing data to it or vice versa. Such a program object is usually called a mutex, which is short for ‘mutual exclusion object’. A mutex is a program object that allows multiple program threads to share the same resource, such as file and memory access, but not simultaneously. When a program is started, a mutex is created with a unique name, identifier, etc. for each shared resource that is used by multiple threads. After this stage, any thread that needs the resource must ‘lock’ the mutex from other threads while it is using the resource. The mutex is unlocked, released, etc. when the data, resource, etc. is no longer needed or the routine is finished. A mutex may be implemented by a semaphore or a binary semaphore, which typically is a hardware or software flag. In multitasking systems, a semaphore is typically a variable with a value that ‘locks’ or indicates the status of a common resource. It is used to obtain information of the resource that is being used. A process needing the resource checks the semaphore to determine the resource's status and then decides how to proceed, e.g. with getting or locking an appropriate mutex.

A problem may arise when a high priority thread and a low priority thread communicate through or use a shared resource that prevents the high priority thread to access the shared resource for too long thereby preventing the high priority thread to perform it's time-critical task as explained in the following. Suppose that the low priority thread ‘owns’ access to the shared resource at a given time and the high priority thread then needs to access the shared resource thereby having to wait until the low priority thread is done. In this situation, an intermediate priority thread (that does not have to use the particular shared resource) may then delay the access of the high priority thread by preempting the low priority thread thereby extending the time that the high (and low) priority thread has to wait by an amount of time equal to the time that the intermediate priority thread uses, which may cause the high priority task to fail performing it's actions in due time.

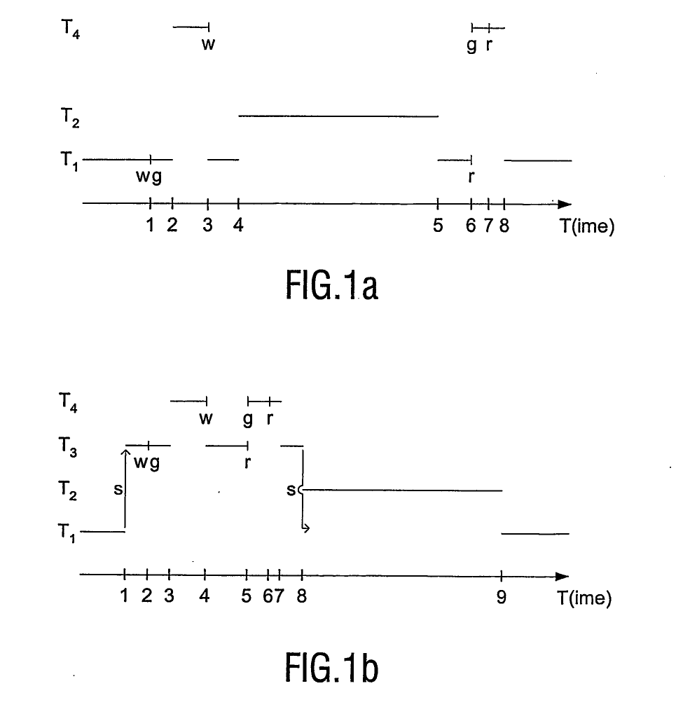

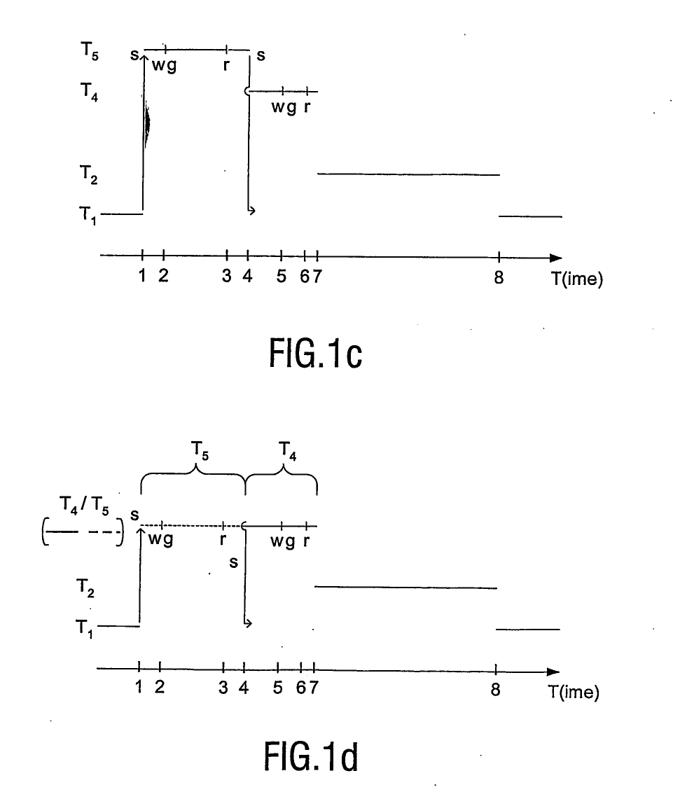

This problem is usually referred to in the literature as ‘priority inversion’ and is explained in greater detail in connection with FIG. 1a.

One previous solution to this particular problem is to implement a ‘priority inheritance’, sometimes called ‘priority promotion’, mechanism where an owning thread temporarily (e.g. the low priority thread) gets a priority equal to the highest priority of the waiting processes/threads. In this way, no intermediate priority process is able to pre-empt the low priority thread and thus delay the waiting time further for the high priority thread.

The Priority Inheritance mechanism has two problems as e.g. disclosed in “Missed it!—How Priority Inversion messes up real-time performance and how the Priority Ceiling Protocol puts it right”, N. J. Keeling (Real-Time Magazine 99-4, 1999). One problem arises when a high priority thread shares multiple resources with other threads, that causes priority inheritance to take too much time, and another problem may arise if multiple threads share multiple resources with each other, whereby priority inheritance will not prevent a deadlock if threads allocate the resources in the wrong order. A solution, called ‘priority ceiling’, to these two problems is proposed in Keeling where an owning thread temporarily gets a priority equal to the highest priority of all threads that are allowed to wait for the mutex of the shared resource.

However, a priority inheritance and a priority ceiling mechanism can not always be used for communication via a shared resource between a high priority thread and a low priority thread whereby an intermediate priority thread (having a priority between the high and low priority thread) may prevent the high priority thread from performing it's actions in time thereby possibly rendering real-time application useless, erroneous, etc. Additionally, the option of a priority inheritance or a priority ceiling mechanism may not always be available or supported e.g. due to restrictions imposed by an operating system running the thread(s). As an example, if e.g. two different operating systems are running on a single processor at a given time, where one of the operating systems is a real-time operating system running the high priority thread and the other operating system is a non-real time system running the low priority thread, then the priority of the low priority thread can not be raised high enough to reach the priority of the high priority thread.

It is an object of the invention to provide a method and system of executing processes with different priorities in a multiprocessing environment where the method and system solves the problems of the prior art.

This is achieved by a method of executing processes with different priorities in a multiprocessing environment comprising execution of a low priority process and a high priority process where the high priority process and the low priority process share a given resource, characterized in that the method comprising the step of: raising an effective priority of the low priority process when the low priority process is going to use the shared resource, where the effective priority is raised to be above a priority of an other process in the multiprocessing environment.

In this way, a high priority process will only be delayed, by other processes, for as short a time as possible so that it will be able to execute it's tasks in due time and no other process, than the high priority, may stall the access of the low priority process to the given resource due to that the ‘effective’ priority is raised.

The effective priority may be raised until the high priority thread has finished other tasks.

No support from the operating system or operating systems can be required other than basic synchronisation and communication means and a strict priority scheme, where a thread cannot be pre-empted by threads with the same or a lower priority.

A preferred embodiment is described in claim 2. In some further embodiments, the additional process may be synchronised with the high priority process, e.g. using a mutex, a Boolean or a semaphore.

In this way, the raising of the ‘effective’ priority of the low priority process is achieved by using an additional thread accessing the given resource on behalf of the low priority (which stays at the same low priority) and communicating with the high priority process, where the additional process may not be stalled, preempted, etc. by other processes other than the high priority process.

An other preferred embodiment is described in claim 6. Alternatively, the effective priority is raised to be equal of greater than the priority of the high priority process.

Preferably, the operating environment is a pre-emptive environment.

In one embodiment, the multiprocessor environment comprises a real-time operating system and a non-real time operating system running on a single processor at least at a given time, where the real-time operating system comprises said high priority thread and said additional process and where the non-real time operating system comprises said low priority thread.

In this way, the multiprocessing system has two sets of threads or processes. All threads compete for time on the same CPU. The threads in the first set are scheduled with strict priority: a thread will not get CPU time if there is a thread with higher priority that needs CPU time as well. The threads in the second set will only get CPU time if none of the threads in the first set needs CPU time. So effectively all threads in the first set have higher priority than the threads in the second group. Threads cannot migrate between the sets. All threads can share memory and use semaphores and mutexes amongst each other.

As an example, the first set may e.g. be scheduled by RTX (=Real Time Extension, by VenturCom Inc.). This set may be used for threads like the high priority thread that do real-time processing. The second set may e.g. be scheduled by Windows NT (by Microsoft). This set may be used for threads like the low priority thread doing background processing and control processing.

This object is further achieved by a system for executing processes with different priorities in a multiprocessing environment comprising means adapted to execute a low priority process (T1) and a high priority process (T4) where the high priority process (T4) and the low priority process (T1) share a given resource (SM4), characterized in that the system comprises:
means for temporarily raising an effective priority of the low priority process (T1) when the low priority process (T1) is going to use the shared resource (SM4), where the effective priority is raised to be above a priority of an other process (T1, T2) in the multiprocessing environment.

Other preferred embodiments of the invention are defined in the sub claims.

FIG. 1a illustrates execution of various threads having different priority according to prior art;

FIG. 1b illustrates execution of various threads having different priority according to the present invention;

FIGS. 1c and 1d illustrates execution of various threads having different priority according to alternative embodiments of the present invention;

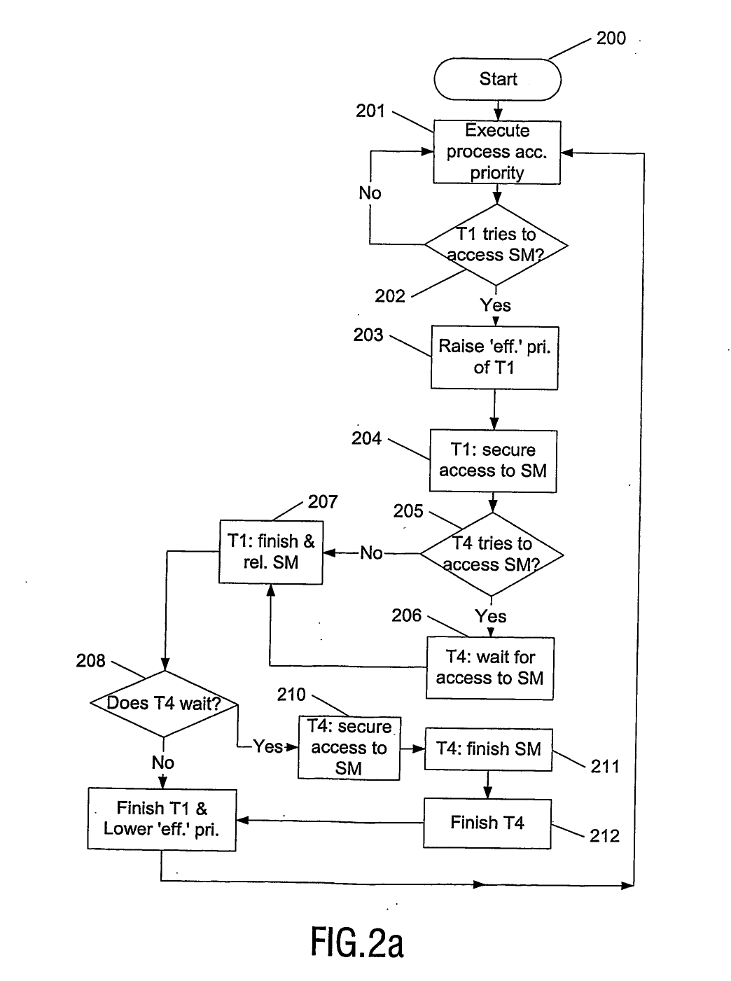

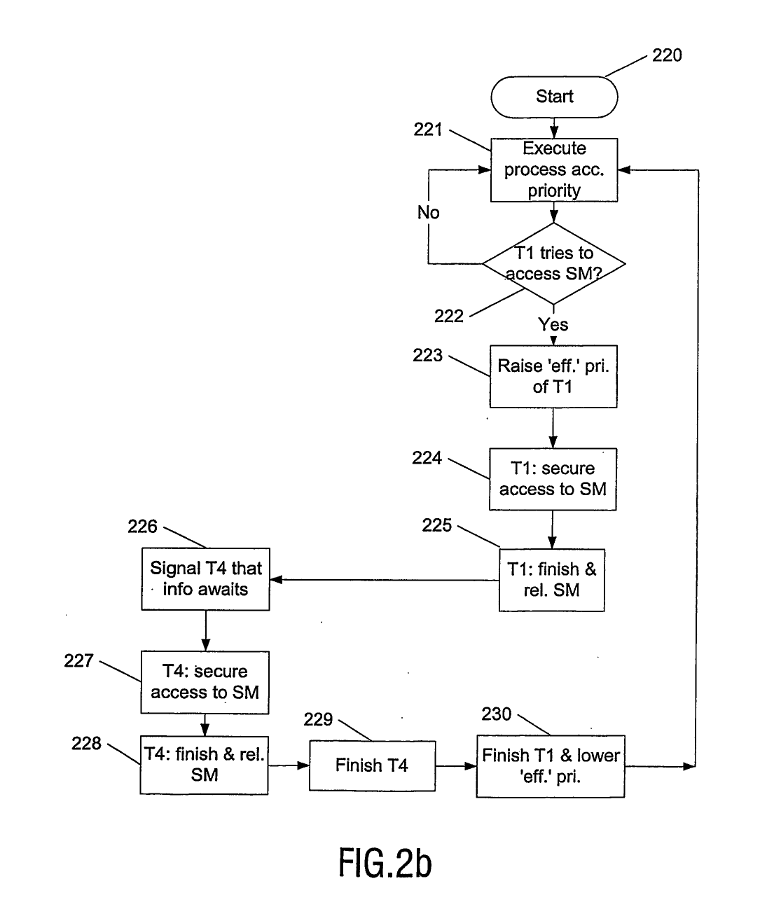

FIG. 2a illustrates an embodiment of the method according to the present invention, where a high priority thread (T4) tries to access the shared resource while a low priority thread (T1) already has access to it;

FIG. 2b illustrates an embodiment of the method according to the present invention where a high priority thread does not try to access the shared resource while a low priority thread already has access to it;

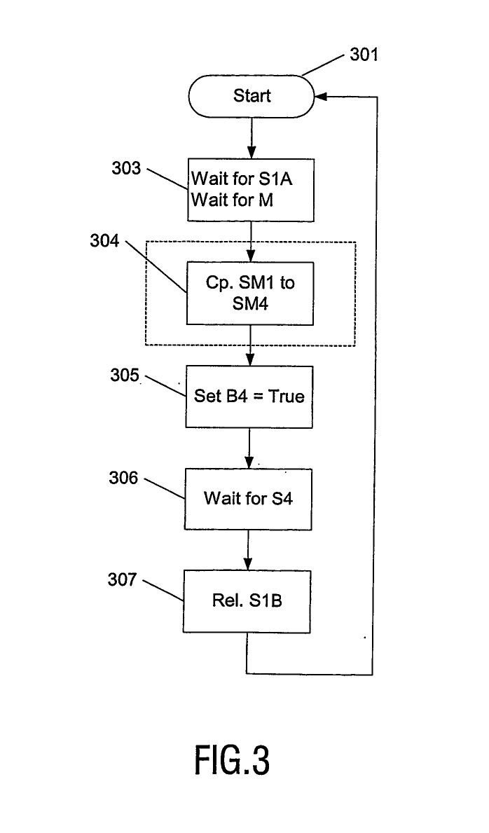

FIG. 3 illustrates a flowchart for an embodiment of an additional thread (T3) according to the present invention;

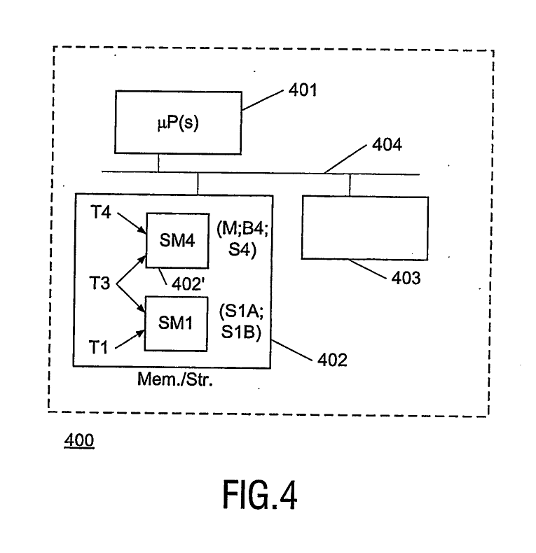

FIG. 4 illustrates a system according to the present invention.

FIG. 1a illustrates the execution of various threads having different priority according to prior art. Shown is a high priority thread, process, task, job, etc. (T4) e.g. performing time-critical actions, a low or relatively lower priority thread (T1) e.g. performing background processing, and an intermediate priority thread (T2) having a priority between T1 and T4. All the threads are being executed in an operating system providing a multiprocessor or multiprocessing environment where only a single thread is active at a time. The figure illustrates when the threads (T4, T2, T1) are active as a function of time. The high priority (T4) and the low priority thread (T1) uses a shared resource like a memory where the access to the shared resource is protected by a mutex (M). ‘wg’ indicates a ‘wait/get mutex (M)’ instruction, command, etc. and ‘r’ indicates ‘release mutex (M)’.

At the start of the timeline, thread (T1) is executing and at time 1 thread (T1) executes a ‘wg’ instruction indicating that thread (T1) wants to use the shared resource e.g. because it needs to write into the shared (between T1 and T4) memory. Since the mutex (M) at time 1 is not ‘owned’ by or allocated to another process, then thread (T1) gets to own the mutex and thereby access to the shared resource until it releases it. At time 2, thread (T1) is pre-empted by the higher priority thread (T4) and at time 3, the thread (T4) issues a ‘wg’ instruction since it tries to access the shared resource, e.g. for reading from a shared memory. Since the mutex (M) is owned by another process at that time, thread (T4) has to wait until the mutex (M) is released and thread (T1), that was pre-empted, continues e.g. with writing to the shared memory. At time 4, another thread (T2) having a priority lower than T4 but higher than (T1) is initiated or activated before T1 is finished using the shared resource. This thread (T2) pre-empts T1 due to the higher priority and is executed until it finishes at time 5. Thread (T2) is not pre-empted by T4 since T4 is in a wait state because the mutex (M) is owned by another thread and has not been released. Thread (T2) does not, in this particular example, use the resource that T4 and T1 share.

At time 5, thread (T2) is done and thread (T1) becomes active. At time 6, thread (T1) is done using the shared resource and releases the mutex (M) after which T4 is able to get the mutex (M) and thereby access to the shared resource. At time 7, thread (T4) is done using the shared resource and releases the mutex (M) and thread (T1) is activated again.

So in this way, a high(er) priority thread (T4) may be locked, delayed, prevented from executing and/or accessing a shared resource, etc. by a thread (T2) with a lower priority but having a higher priority than a thread (T1) that (T4) shares the resource with. This is very unfortunate, especially for high priority threads responsible for time-critical tasks since they may be unable to perform these time-critical actions.

FIG. 1b illustrates execution of various threads having different priority according to the present invention. Shown is a high priority thread, process, task, job, etc. (T4) e.g. performing time-critical actions, a low or relatively lower priority thread (T1) e.g. performing background processing, an intermediate priority thread (T2) having a priority between T1 and T4, and an additional thread (T3) having a priority lower than T4 but higher than the other threads (T1 and T2). The figure illustrates when the threads (T4, T3, T2, T1) are active as a function of time. At time 1 the low priority thread (T1) indicates that it wants to access a resource that it shares with the high priority thread (T4). This indication may e.g. be done by using or setting a semaphore. When this indication occurs, the additional thread T3, having a priority lower than T4 but higher than the other threads (T1 and T2), pre-empts T1 and performs, at time 2, the actual execution of a ‘wg’ instruction in order to access the shared resource whereby a mutex (M) for the shared resource is locked, reserved, etc. In this way, T3 accesses the shared resource on behalf of T1, i.e. T1 will not access the shared resource directly. T3 and T1 are synchronized, at time 1, as indicated by the ‘s’, preferably using a semaphore. Usually, semaphores are used to synchronise and a shared resource or memory is used for communication. Alternatively, message passing may be used where the message(s) communicate the information and the sending or receiving of a message can be used for synchronisation.

At time 3, the high priority thread T4 pre-empts T3 and before time 4 it tries to access the shared resource. However, since the shared resource is already in use by T3 (on behalf of T1), T4 goes into a wait state after issuing a ‘wg’ instruction at time 4. Since T4 is waiting ‘w’, T3 (having the next highest priority) resumes execution. At time 5, T3 is done using the shared resource and issues a release instruction ‘r’ for the mutex (M), after which T4 pre-empts T3 and gets or locks ‘g’ the mutex (M) so that it may access the shared resource. At time 6, T4 is done using the shared resource and releases ‘r’ the mutex ( ). At time 7, T4 is done executing its e.g. time-critical task and T3 becomes active. At time 8, T3 is finished and is synchronized with T1 once again e.g. as indicated by using/setting a semaphore, using message passing, etc., after which the thread T2 pre-empts T1 and executes until it is finished at time 9 whereby T1 resumes.

T3 and T1 may communicate by any appropriate mechanism, e.g. via shared memory and/or using semaphores. T3 will own the mutex (M) as short as possible since it can only be pre-empted by T4 (and not by any intermediate threads like T2) and will not wait for T1 as long as it owns the mutex (M). Normally, T3 could wait for T1 if T1 has not yet given any instructions or information to T3 by waiting for e.g. a semaphore that will eventually be released by T1. However, this will not occur when T3 accesses the mutex (M) on behalf of T1.

In general, T4 may still be blocked by T3 for a short while after T4 is in a wait state for the shared resource and until T3 has finished using the shared resource, but during this time T3 will not be stalled by T1 (or indirectly by T2).

In general, T1 is given an ‘effective’ priority that is higher when it needs to access the shared resource. This is in one embodiment achieved by using an additional thread (T3) with a priority below T4 and above other threads (T1 and T2) where T1 and T3 are synchronised and where T3 accesses the shared resource on behalf of T1.

In this way, it is not possible for an intermediate thread (T2), that does not use the resource shared between T1 and T4, to delay the high priority thread (T4) thereby ensuring that the e.g. time-critical tasks of the high priority thread is executed in time.

In one embodiment, the priority of T3 just needs to be between T4 and the rest (T1 and T2). However a new process with a new priority greater than T1, T2 and T3 may delay T4 like described in connection with FIG. 1a. So, preferably, the priority of T3 is slightly lower than that of T4 and higher than the others (T1 and T2). In this way, no other processes than T4 may pre-empt T3 and thus delay T4 further.

In an alternative embodiment, the effective priority of the low priority thread (T1), e.g. implemented by an additional thread T3 synchronised and accessing the shared resource on behalf of T1, is raised to be equal to or alternatively higher than the priority of T4. Let us call such a thread T5. However, such a thread should be programmed with great care since it may spoil the real-time performance of T4. However, typically T5 uses little CPU time for the purpose according to the present invention. These alternatives are shown in FIG. 1c (effective priority raised above T4) and FIG. 1d (effective priority equal to that of T4). In FIG. 1d a full line indicates T4 and a broken line T5 and the bracers indicates when which thread (T4 or T5) is active. Here it is shown that T4 and other threads (T2) may not pre-empt T5 after time 1 where T1 is syncrhonised with the additional thread (T5). T5 waits, gets and releases the mutex (M) at time 2 and 3. At time 4 T4 becomes active and waits, gets, and releases the mutex (M) at time 5 and 6, before T2 and T1 becomes active at time 7 and 8, respectively. In this way any additional threads (T2) does not delay the time critical thread (T4). In the case when T4 and T5 have the same priority (FIG. 1d), T4 can still not preempt T5 in some operating systems e.g. like RTX. If T4 happens to have an important task at exactly, which is quite unlikely, time 1 either T4 or T5 may start. If T4 starts before T5 it finishes its time-critical task(s) before T5 accesses the shared resource on behalf of T1 after which T4 will access the shared resource like illustrated in FIG. 1d (time 1 to time 7). If T5 starts before T5 it corresponds to the situation shown in the Figure.

FIG. 2a illustrates an embodiment of the method according to the present invention, where a high priority thread (T4) tries to access the shared resource while a low priority thread (T1) already has access to it. The method starts at step (200). At step (201) the processes/threads in the multi-process environment are executed normally according to their priority. At step (202) a test, indication, etc. is made whether the low priority thread (T1) needs to access the shared resource, like a shared memory (SM). If this is not the case the method executes processes normally at step (201). If this is the case, the method proceeds to step (203) where the ‘effective’ priority of T1 is raised according to the present invention. At step (204), T1 secures access to the shared resource, e.g. by getting a mutex (M) for the shared resource, and T1 starts using SM. At step (205) it is determined if the high priority thread (T4) tries to access the shared resource while T1 owns the mutex (M). If this is the case, T4 waits for the mutex (M) to be released and enters a wait state at step (206). If T4 does not need access to the shared resource (SM) or T4 is waiting, T1 finishes with and releases the mutex (M) for the shared resource (SM) at step (207). After T1 is finished with the shared resource (SM), it is determined if T4 waits at step (208). If this is not the case, T1 finishes it's processing (involving other things than access to the shared resource (SM)) and the ‘effective’ priority for T1 is lowered to its normal low priority. The ‘effective’ priority may be lowered immediately after T1 is done using the shared resource (SM) (step (207)) and before T1 finishes any other tasks. After step (209) the method proceeds to step (201) where processes are run normally. If T4 did wait at step (208), T4 pre-empts T1 and secures the access to the shared resource (SM), e.g. by getting the mutex (M) at step (210), after which, T4 finishes with SM, at step (211), and possibly with other tasks, at step (212), before proceeding to step (209).

In this way, no other processes, threads, etc. (other than T4) may pre-empt T1 after step (203), thereby ensuring that T4 does not get stalled for too long. It may happen that T4 wants access to the shared resource after step (203) and before step (204). In this case it will immediately get the mutex, use the shared resource, and release the mutex again. One way of avoiding that T4 pre-empts T1 (or T3) is by having an effective priority equal or higher than the priority of T4 as illustrated in connection with FIG. 1c and 1d.

If the step of raising the ‘effective’ priority for T1 is implemented, as explained above and in the following, using an additional thread (T3) accessing the shared resource on behalf of T1 and having a priority below T4 and above the other processes step (203) would invoke T3 on behalf of T1 and in the steps (204, 207, 209) it would read T3 instead of T1. T1 and T3 would preferably be synchronised at step (203) and step (209). This implementation is explained in greater detail in connection with FIG. 3.

FIG. 2b illustrates an embodiment of the method according to the present invention where a high priority thread (T4) does not try to access the shared resource while a low priority thread (T1) already has access to it. The steps (220-224; 225) correspond to the step (200-204; 207) in FIG. 2a. After T1 has released access to the shared resource (SM) at step (225) a signal, indication, etc. is given, at step (226), to T4 that information, data, etc. waits e.g. using a Boolean (B4), a semphore or massage passing.

At step (227), T4 pre-empts T1 and secures the access to the shared resource, e.g. by getting the mutex (M) and at step (228), T4 uses and releases the resource (SM). At step (229), T4 finishes other tasks not related to accessing the shared resource (SM), if any. At step (230), T1 resumes execution and finishes. The ‘effective’ priority is lowered (may also be done at step (225) and the method returns to step (221). However, it is not as advantageously to reduce the ‘effective’ priority at step (225) instead of step (230), since T2 may pre-empt T1 before step (226), so it may take a longer time before T4 is signalled.

If the step of raising the ‘effective’ priority for T1 is implemented, as explained above and in the following, using an additional thread (T3) accessing the shared resource on behalf of T1 and having a priority below T4 and above the other processes step (223) would invoke T3 on behalf of T1 and in the steps (224, 225, 226, 230) it would read T3 instead of T1. T1 and T3 would preferably be synchronised at step (223) and step (230). T3 and T4 would preferably be synchronised at step (226) if needed e.g. using the mutex (M) or a Boolean (B4) and a semaphore (S4). However, T3 and T4 do not have to be synchronised in all cases, since for some applications it is sufficient that T4 simply is signalled that information waits. This implementation is explained in greater detail in connection with FIG. 3. Alternatively, the raising of the ‘effective’ priority may be implemented by a thread having a priority equal to or greater than the priority of T4 as described elsewhere.

FIG. 3 illustrates a flowchart for an embodiment of an additional thread (T3) according to the present invention. In this particular embodiment, the additional thread (T3) communicates (on behalf of the low priority thread (T1)) with the high priority thread (T4) via a shared memory (SM4) that is protected by a mutex (M) and synchronized by a Boolean (B4) and a semaphore (S4). T3 communicates with the low priority thread (T1) via a shared memory (SM1) that is synchronized by semaphores S1A and S1B. In this particular example, information, data, etc. is to be transferred from the low priority thread (T1), using a shared memory (SM1), to the high priority thread (T4), using a shared memory (SM4), via the additional thread (T3).

At step (301) the method is initialised where processes and initial values for parameters, etc. are set up. In this particular example the Boolean (14) is set to false indicating that no information, data, etc. is ready/available for T4.

At step (303) the embodiment of T3 waits for an indication that T1 needs to send information to/communicate with T4. Other processes (including T1 and T3) may be run normally during the waiting. The waiting may e.g. be done by waiting for a semaphore (S1A), i.e. to wait for that T1 has accessed the shared resource (SM1) and e.g. put info or data in the shared memory (SM1), and second to wait for the mutex (M) to be released. After/if the mutex (M) is available it is reserved/held by T3 so that T3 may access the shared memory (SM4). At step (304) content from the shared memory (SM1) is copied to the shared memory (SM4). After the information is transferred the mutex (M) is released so that other processes may use the shared resource. At step (305) the Boolean (B4) is set to ‘true’ in order to signify to T4 that there is information available. At step (306) the method waits for the semaphore (S4) signifying whether T4 has accessed/used the information, data, etc. in the shared memory (SM4). After T4 has used the information, the semaphore (S1B) is released, at step (307), signifying to T1 that the shared resource (SM1) may be used for other purposes, i.e. that T4 is done, after which the method starts over until a new communication needs to be made.

The pseudo code for this exemplary embodiment of the additional thread (T3) is:

| Boolean B4 := false | |
|---|---|
| while forever do | |
| { | |
| wait for S1A; | // Wait until T1 has put info in SM1. |
| wait for M; | |
| copy SM1 to SM4; | |
| release M; | |
| B4 := true; | // Tell T4 that there is info. |
| wait for S4; | // Wait until T4 has used info in SM4. |
| release S1B; | // Tell T1 that SM1 can be filled with |
| | // other info. |
| } | |

In this embodiment, T4 will usually often (e.g. in a while loop) do: if (B4=true)

```
if (B4 == true)
{
  B4 := false;
  wait for M;
  use info in SM4;
  release M;
  release S4;
}
```

B4 and S4 provide an extra synchronisation that may be useful in some applications, although making the embodiment more complex. Alternatively, B4 and S4 may be removed from the embodiment.

Alternatively, the method may use cyclic buffers and/or different synchronization means or schemes. Additionally, the copy action (304) from SM1 to SM4 may be omitted or replaced with another action (e.g. a copy action from SM4 to SM1 if information is to be transferred from T4 to T1, etc.), since it is only used for transferring data from T1 to T4. Another example is using ‘remote procedure call’, where first procedure parameters are copied from T1 to T4, then T4 executes a procedure, and then the procedure copies the result back to T1. This however, requires more synchronization than in the above example. It can also be made to work in the opposite direction.

In the context of this exemplary embodiment for T3, FIG. 1b may represent a situation where T1 writes data, information, and etc. (via T3) into a shared memory (SM4) in order for T4 to read but where T4 tries to access the shared memory (SM4) before T1 has done writing to it.

The lines of the pseudo code may correspond to the times of FIG. 1b according to:

| | |
|---|---|
| { wait for S1A; | (Corresponds to T = 1) |
| wait for M; | (T = 2) |
| copy SM1 to SM4; | (Between T = 2 and T = 5) |
| release M; | (T = 5) |
| B4 := true; | (Before T = 7) |
| wait for S4; | (T = 7) |
| release S1B; | (T = 8)} |

‘B4:=true’ is actually not used in the situation in FIG. 1b since T4 already tries to get access to SM4 before T1 (T3) is finished. Otherwise this would signal to T4 that it should access SM4 in order to retrieve information.

FIG. 4 illustrates a schematic block diagram of an embodiment of a system according to the present invention. Shown is a system (400) according to the present invention comprising one or more micro-processors (401) connected with a memory and/or a storage (402) and other devices or functionalities (403) via a communications bus (404) or the like. The micro-processor(s) (401) is(are) responsible for executing the various processes, threads, etc. (T1, T2, T3, T4), for executing the method according to the present invention as well as other software like operating system(s), specialised programs, etc. using the threads, and for synchronising the threads according to the present invention.

The memory or storage (402) comprises a shared resource (402′) like a shared memory (SM4) or file or part thereof, shared by the threads T4 and T3, and another shared memory (SM1) or file, shared by threads T3 and T1). The shared resource may e.g. be a shared Input/Output (I/O) device, e.g. comprising a memory, where one thread may write to the memory and another may read from it. Indicated, is also which synchronisation means that is used with respect to synchronising the various threads for the exemplary embodiment described in connection with FIG. 3. For SM4 it is a Boolean (134) and a semaphore (S4) where a mutex (M) controls the access to SM4, and for SM1 it is a first semaphore (S1A) and a second semaphore (S1B).

The other devices or functionalities (403) may e.g. be a display, a communication device, a network device, etc.

One example of a system that may use the present invention is e.g. a MPEG-2 re-multiplexing device that may be used in cable systems, terrestial systems, satellite systems, etc. that broadcast Digital Video, etc. Also a receiver of digital video or audio like a set-top box or digital television set can comprise the system according to the invention. The MPEG-2 streams are processed in real-time by software threads that run under a real-time operating system e.g. RTX. Typically much of the control software runs on the same processor under a non real-time operating system e.g. Windows NT. A high priority thread (T4) may be such a stream processing thread under the real-time operating system RTX and a low priority thread (T1) may be a control processing thread under Windows NT. RTX does offer priority promotion, but this is not available between threads on RTX and threads on Windows NT. So according to the present invention it is avoided that a time-critical thread (T4) is stalled for a long time by intermediate priority threads (T2) like Windows NT interrupts, deferred procedure calls, etc. In this way, communication of control commands from Windows NT threads to RTX threads, communication of error messages from RTX threads to Windows NT threads, etc. is achieved without the above-mentioned drawbacks.

1. A method of executing processes with different priorities in a multiprocessing environment comprising execution of a low priority process (T1) and a high priority process (T4) where the high priority process (T4) and the low priority process (T1) share a given resource (SM4, 402′), characterized in that the method comprising the step of:
temporarily raising an effective priority of the low priority process (T1) when the low priority process (T1) is going to use the shared resource (SM4, 402′), where the effective priority is raised to be above a priority of an other process (T1, T2) in the multiprocessing environment.

2. Method according to claim 1, characterized in that the step of raising the effective priority comprises the steps of:
executing/assigning an additional process (T3, T5) accessing the shared resource (SM4, 402′) on behalf of the low priority process (T1) where the additional process (T3, T5) has a priority equal to the effective priority, and
where the additional process (T3, T5) is synchronised with the low priority process (T1).

3. Method according to claim 1, characterized in that the multiprocessor environment comprises a real-time operating system and a non-real time operating system running on a single processor at least at a given time, where the real-time operating system comprises said high priority thread (T4) and said additional process (T3, T5) and where the non-real time operating system comprises said low priority thread (T1).

4. Method according to claim 2, characterized in that
the additional process (T3) and the low priority process (T1) are synchronised using a first semaphore (S1A) and a second semaphore (S1B).

5. Method according to claim 1, characterized in that the effective priority is raised at least until
the low priority process (T1) has accessed or used the shared resource (SM4, 402′), or
the high priority process (T4) has accessed or used the shared resource (SM4, 402′) if the high priority process (T4) attempts to access or use the shared resource (SM4, 402′) while the low priority process (T1) has access or uses the shared resource (SM4, 402′).

6. Method according to claim 1, characterized in that the effective priority of the low priority process (T1) is raised to be slightly below that of the high priority process (T4).

7. Method according to claim 4, characterized in that access to the shared resource (SM4, 402′) is controlled by a mutex (M) whereby said additional process (T3, T5) will not wait for the low priority process (T1) as long as it owns the mutex (M).

8. Method according to claim 1, characterized in that the shared resource (SM4, 402′) is selected from the group of:
a shared memory (SM4, 402′),
a shared file (SM4, 402′), and
a shared input/output (I/O) device.

9. Method according to claim 1, characterized in that the high priority process (T4) executes time-critical tasks.

10. A system (400) for executing processes with different priorities in a multiprocessing environment comprising means (401) adapted to execute a low priority process (T1) and a high priority process (T4) where the high priority process (T4) and the low priority process (T1) share a given resource (SM4, 402′), characterized in that the system comprises:
means (401) for temporarily raising an effective priority of the low priority process (T1) when the low priority process (T1) is going to use the shared resource (SM4, 402′), where the effective priority is raised to be above a priority of an other process (T1, T2) in the multiprocessing environment.

11. System (400) according to claim 10, characterized in that the means (401) for raising the effective priority is conceived to:
executing an additional process (T3, T5) accessing the shared resource (SM4, 402′) on behalf of the low priority process (T1) where the additional process (T3, T5) has a priority equal to the effective priority, and
where the system (400) comprises synchronisation means (401) conceived to synchronise the additional process (T3, T5) with the low priority process (T1).

12. System (400) according to claim 10, characterized in that the system comprises a single processor (401) comprising a real-time operating system and a non-real time operating system running on the single processor (401) at least at a given time, where the real-time operating system comprises said high priority thread (T4) and said additional process (T3, T5) and where the non-real time operating system comprises said low priority thread (T1).

13. A computer readable medium having stored thereon instructions for causing one or more processing units to execute the method according to claim 1.

14. Set-top box comprising the system according to claim 10.

15. Television set comprising the system according to claim 10.
